(19) United States
(12) Patent Application Publication
(10) Pub. No.: US 2026/0328648 A1
(43) Pub. Date: Oct. 22, 2026

(54) METHOD AND SYSTEM FOR IDENTIFYING A STATE OF HEALTH OF A VIBRATORY SYSTEM

(71) Applicant: Caterpillar Paving Products Inc., Brooklyn Park, MN (US)

(72) Inventor: Derek Peter Nieuwsma, Loretto, MN (US)

(73) Assignee: Caterpillar Paving Products Inc., Brooklyn Park, MN (US)

(21) Appl. No.: 19/181,510

(22) Filed: Apr. 17, 2025

(51) Int. Cl. G01M 13/00; E01C 19/28; G01L 15/00; H02K 7/075

(52) U.S. Cl. CPC G01M 13/00; E01C 19/286; G01L 15/00; H02K 7/075; E01C 2301/00

(57) ABSTRACT

A system for monitoring a vibratory system of a vibratory compactor machine. The system for monitoring includes a vibratory system associated with a drum of the vibratory compactor machine and a sensor associated with the vibratory system. The system also includes a controller in electrical communication with the sensor. The controller is configured to receive sensor data from the sensor, compare the sensor data to a criteria, and identify a state of health of the vibratory system based on the sensor data satisfying the criteria for a period of time. In some examples, the system for monitoring can additionally send an alert to an operator or remote office indicating the vibratory compactor machine is being operated in a manner that reduces the lifespan of one or more components on the vibratory compactor machine.

### TECHNICAL FIELD

This disclosure relates to vibratory compaction equipment, and more specifically to methods and systems for predictive wear using vibratory system pressures.

### BACKGROUND

Compactors are machines used to compact initially loose materials, such as asphalt, soil, gravel, and the like, to a densified and more rigid mass or surface. For example, soil compactors are utilized to compact soil at construction sites and on landscaping projects to produce a foundation on which other structures may be built. Most soil compactors include a rotatable drum that may be rolled over the surface to compress the material underneath. In addition to utilizing the weight of the drum to provide the compressive forces that compact the material, some compactors include vibratory systems configured to also induce a vibratory force to the surface. A description of a vibratory system useable with a compactor machine can be found in U.S. Patent Application Publication No. 2022/0127797.

Some vibratory systems are configured to operate in two or more modes. For example, the vibratory system can generate a first vibratory force amplitude in a first mode and a second vibratory force amplitude in a second mode. The first vibratory force amplitude can generate a higher vibratory force to increase the compressive forces compacting the worksite material. Additionally, the second vibratory force amplitude can be less than the first vibratory force amplitude for construction sites or soil that is already or at least partially compacted. Accordingly, machine operators can adjust the operation of the compactor based on the condition of the work site or the needs of the project.

### SUMMARY

Disclosed herein is a system for monitoring a vibratory system of a vibratory compactor machine. The system for monitoring includes a vibratory system associated with a drum of the vibratory compactor machine; a sensor associated with the vibratory system; and a controller in electrical communication with the sensor. The controller is configured to receive sensor data from the sensor and compare the sensor data to a criteria. The controller further identifies a state of health of the vibratory system based on the sensor data satisfying the criteria for a period of time. In some examples, the system for monitoring can additionally or alternatively alert an operator in a back office.

Also disclosed herein is a vibratory compactor machine. The vibratory compactor machine includes a vibratory compactor. The vibratory compactor includes a frame, an engine secured to the frame, and a drum rotatable relative to the frame and operatively coupled to the engine. The vibratory compactor machine also includes a vibratory system. The vibratory system includes a mount indirectly secured to the drum, a motor fixedly secured to the mount, and an eccentric weight operably coupled to the motor. The vibratory compactor machine also includes a sensor associated with the vibratory system and a controller in electrical communication with the sensor. The controller is configured to receive sensor data from the sensor, compare the sensor data to a criteria, and identify a state of health of the vibratory system. The controller identifies a state of health of the vibratory system based on the sensor data satisfying the criteria for a period of time.

Further disclosed herein is a method. The method includes activating a motor of a vibratory system. The vibratory system including at least one mount, a shaft rotatably coupled to the mount, and an eccentric weight disposed on the shaft. In accordance with the method, activation of the motor causes the eccentric weight to rotate about the shaft or with the shaft. The method also includes receiving, at a controller, sensor data generated by a sensor operably coupled to the vibratory system. Further, the method includes identifying, via the controller, the sensor data satisfies a criteria. Also, the method includes predicting, via the controller, a state of health of the vibratory system based on the sensor data satisfying the criteria.

### BRIEF DESCRIPTION OF DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a side view of a vibratory compactor machine according to one or more embodiments of the disclosed subject matter.

FIG. 2 is a schematic diagram of the vibratory compactor machine according to one or more embodiments of the disclosed subject matter.

FIG. 3 is a perspective view of the vibratory system of the compactor machine according to one or more embodiments of the disclosed subject matter.

FIG. 4 is a cross-sectional view along line A-A of FIG. 3 of an adjustable eccentric mass of a vibratory mechanism adapted to cause vibration according to a first vibration amplitude.

FIG. 5 is a cross-sectional view along line A-A of FIG. 3 of an adjustable eccentric mass of a vibratory mechanism adapted to cause vibration according to a second vibration amplitude.

FIG. 6 is example histogram of pressure data of the example vibratory system of FIGS. 2–5.

FIG. 7 is a second example histogram of pressure data of the example vibratory system of FIGS. 2–5.

FIG. 8 is a flow chart of a method for identifying a state of health of the vibratory system according to one or more embodiments of the disclosed subject matter.

### DETAILED DESCRIPTION

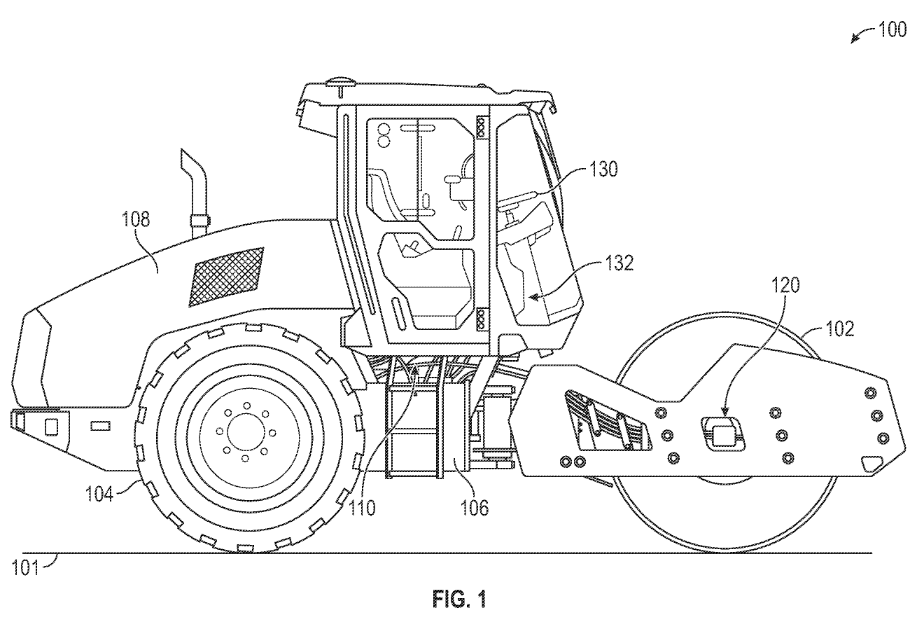

FIG. 1 shows an example vibratory compactor machine 100. The vibratory compactor machine 100 can be used, for example, for soil compaction, road construction, highway construction, parking lot construction, and other such paving and/or construction applications. The vibratory compactor machine 100 may make one or more passes over a worksite surface 101 to provide a desired level of compaction. Along with compacting primarily earth-based materials of the worksite surface 101, in other examples, the vibratory compactor machine 100 may also be configured to compact freshly deposited asphalt or other materials disposed on and/or associated with the worksite surface 101.

The vibratory compactor machine 100, according to the example shown in FIG. 1, can include a drum 102 and wheels 104. In such an example, the drum 102 compacts the worksite surface 101 and the wheels 104 propel the vibratory compactor 100 forward and backward. In some examples, the drum 102 can also propel the vibratory compactor 100 forward and backward. Though in an alternative embodiment the drum 102 can be a first drum and the wheels 104 can be a second drum. In such an alternative embodiment, both the first and second drums compact the worksite surface 101 and at least one of the first and second drums can propel the vibratory compactor 100 forward and backward. Drums according to embodiments of the disclosed subject matter may be referred to as compacting rollers or compaction rollers.

The compactor machine 100 can include a chassis or frame 106, an engine 108 (or electric motor) secured to the frame 106, a hydraulic system 110 operatively coupled to the drum 102 and the wheels 104. The hydraulic system 110 is operatively coupled to and powered by the engine 108. In the present example, the hydraulic system 110 is operably coupled with the drum 102, wheels 104, and steering to control movement and direction of the compactor machine 100.

The drum 102 and wheels 104 are secured to the frame 106. For example, the drum 102 and wheels 104 are rotatable relative to the frame 106 and operatively coupled to the engine 108 such that the drum 102 can rotate clockwise or counterclockwise depending upon controls according to a direction of travel, i.e., forward or reverse, respectively, of the vibratory compactor machine 100. The first drum 102 (an in some examples, a second drum) may be cylindrical or in the form of cylinders, though drums according to embodiments of the disclosed subject matter are not so limited in geometrical configuration. For example, the drum(s) 102 could include a padfoot drum.

A vibratory system 120 may be provided for the drum 102. In some examples, when the vibratory compactor 100 includes a first and second drum, The vibratory system 120 can be utilized for both the first and second drums. But, in other examples, the vibratory compactor 100 can include a separate vibratory system for each drum.

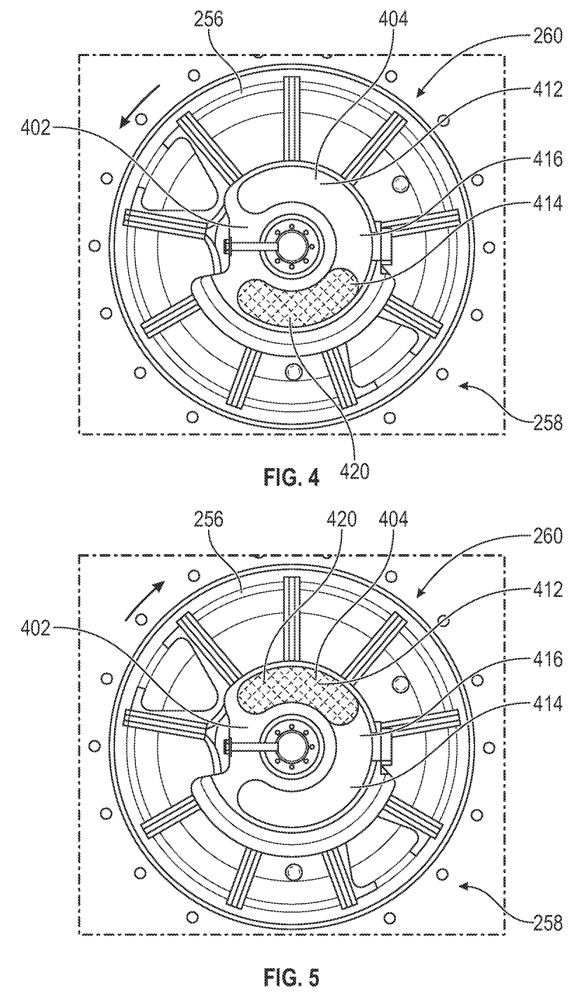

In the present example, the vibratory system 120 is, at least partially, disposed inside the interior volume of the drum 102. As will be discussed in greater detail below, the vibratory system 120 includes an eccentric weight (shown in FIGS. 4–5). During operation of the vibratory compactor machine 100, the eccentric weight of the vibratory system 120 induces oscillatory or vibrational forces to the drum 102. The vibrational forces are imparted to the worksite surface 101 through the drum 102. As will be discussed in greater detail below, the eccentric weight can be configured to provide two or more vibrational amplitudes.

The vibratory compactor machine 100 also includes a user interface 130 and a controller 132 or other control circuitry. In various examples, the controller 132 can comprise two or more controllers or microcontrollers. Additionally, while shown as being disposed on the vibratory compactor machine 100, in some examples, the controller 132 is not disposed on the vibratory compactor machine or only part of the controller 132 is disposed on the vibratory compactor machine 100. In some such examples, all or part of the controller 132 is implemented in a local or remote server that is in communication with the vibratory compactor machine 100. The user interface 130 includes various controls and displays to permit a person to control the operation of the vibratory compactor machine 100. The user interface 130 is operatively coupled with the controller 132 such that the user interface 130 and the controller 132 can receive and transmit between each other. The controller 132 includes a processor (or processing circuitry) and memory for operating the vibratory compactor machine 100. As a result, in various examples, the controller 132, in response to receive commands from the user interface 130, controls operation of the vibratory compactor 100 including the drum 102, the wheels 104, and the vibratory system 120.

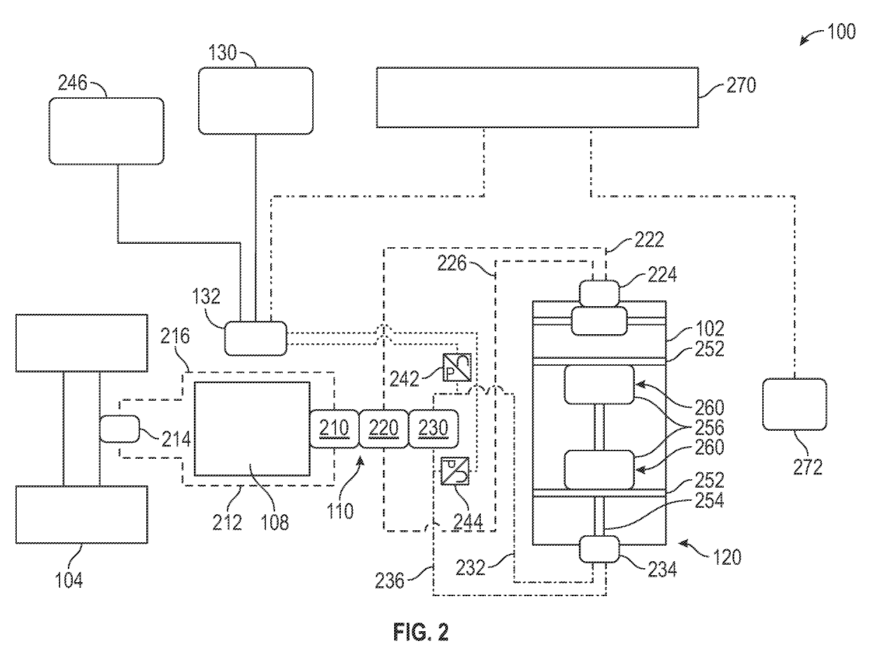

FIG. 2 illustrates a schematic of the vibratory compactor machine 100 including the engine 108, hydraulic system 110, vibratory system 120, and controller 132. As shown, the engine 108 is operatively coupled with the hydraulic system 110 and powers the hydraulic system 110. In some examples, the engine 108 is an internal combustion engine, but in other examples, the engine 108 could be an electrical motor or other engine or motor capable of actuating the hydraulic system 110.

The hydraulic system 110 includes a first hydraulic pump 210 connected with a first hydraulic line 212, a first hydraulic motor 214 coupled to the first hydraulic line 212, and a second hydraulic line 216 coupled to the first hydraulic pump 210 and the first hydraulic motor 214, forming a closed loop. The hydraulic system 110 also includes a second hydraulic pump 220 connected with a first hydraulic line 222, a second hydraulic motor 224 coupled with the first hydraulic line 222, and a second hydraulic line 226 coupled to the second hydraulic pump 220 and the second hydraulic motor 224. forming a closed loop. The hydraulic system 110 further includes a third hydraulic pump 230 connected with a first hydraulic line 232, a vibratory motor 234 coupled with the first hydraulic line 232, and second hydraulic line 236 coupled with the third hydraulic pump 230 and the vibratory motor 234, forming a closed loop. In various examples, the vibratory compactor machine 100 can include more or fewer hydraulic pumps. Each of the first, second, and third hydraulic pumps 210, 220, 230 can operate in a first direction (pumping first through the first hydraulic lines 212, 222, 232) through the motors 214, 224, 234 and can operate in a second direction (pumping first through the second hydraulic lines 216, 226, 236) through the motors 214, 224, 234. As a result, the first and second hydraulic pumps 210, 220 can cause the drum 102 and wheels 104 to rotate in either a forwards or backwards direction. Additionally, as discussed below in connection with FIGS. 4 and 5, the third hydraulic pump 230 can cause the eccentric weight to rotate in at least a first state and a second state. Furthermore, the controller 132 can control operation of the engine 108 and the pumps 210, 220, 230 to selectively operate all or a subset of the pumps 210, 220, 230.

The third hydraulic pump 230 further includes a first pressure sensor 242 on the first hydraulic line 232 and a second pressure sensor 244 on the second hydraulic line. In some examples, the first and second pressure sensors 242, 244 are a differential pressure sensor in fluid connection with each of the first and second hydraulic lines 232, 236. Both of the first and second pressure sensors 242, 244 are in electrical communication with, or otherwise operatively connected to, the controller 132. As a result, the controller 132 can calculate a pressure differential across the third hydraulic motor 234. During normal operation, because the first and second pressure sensors 242, 244 are associated with the vibratory system 120, the pressure differential across the hydraulic motor 234 can be used to determine the level of compaction of the worksite surface 101. For example, after the worksite surface 101 is sufficiently compacted, the vibrational force exerted on the worksite surface 101 through the drum can reverberate back into the vibratory system 120, the vibratory compactor 100, and can also be measured as elevated levels of differential pressure between the first and second pressure sensors 242, 244.

The hydraulic system 110 could be differently configured or sized in accordance with this disclosure. In some examples, two or more of the hydraulic pumps 210, 220, 230 can be combined as a single hydraulic pump. Additionally, in some examples, one or more of the hydraulic pumps 210, 220, 230 could be coupled to a separate engine or power source.

Additionally, the vibratory compactor machine 100 can additionally include a variety of other sensors 246 operationally connected to the controller 132. In various examples, the sensors 246 can include a wide variety of sensors, including, accelerometers, global positioning systems (GPS), temperature sensors, engine and/or motor speed sensors (e.g., tachometer), position sensors, voltage sensors, electrical current sensors, fuel level sensors, chronometer, etc. The sensors 246 are configured to generate sensor data and transmit the sensor data to the controller 132. In some examples, any of the sensors 246 could be operably coupled to the vibratory system 120 and functionally replace the first and second pressure sensors 242, 244. For example, if the hydraulic pump 230 and hydraulic motor 234 are replaced with an electric motor, the first and second pressure sensors 242, 244 can be replaced with electrical current sensors to ascertain operational data on the electric motor.

In various examples, the controller 132 receives the sensor data generated by the sensors 242, 244, 246, operably coupled to the vibratory system 120 or otherwise disposed on the vibratory compactor machine 100. The controller 132 utilizes the sensor data for operating the vibratory compactor machine 100. In various examples, the controller 132 can store sensor data or transmit data to remote data storage (e.g., data center) for future review or analysis or use sensor data to adjust or update operation of the vibratory system 120. Additionally, as will be discussed in greater detail below, the controller 132 can utilize the sensor data to identify a state of health of the vibratory system 120 and/or the vibratory compactor machine 100. In some examples, the state of health of the vibratory system further indicates an impending failure of a component of the vibratory system 120.

As shown in FIG. 2, the vibratory system 120 includes a mount 252 that secures the vibratory system 120 and a shaft 254 rotatable relative to the motor 234. The vibratory system 120 further includes the third hydraulic pump 230 and the motor 234 operably coupled to the shaft 254 and fixedly secured to the mount 252. The vibratory system 120 further includes pods 256 secured to the drum 102, each pod 256 including an eccentric weight 260 disposed within the pods 256 and rotatable with or about the shaft 254. In the present example, the motor 234 causes the shaft 254 and the eccentric weight 260 to rotate in either a first or second direction. In the present example, the shaft 254 and the eccentric weight 260 are rotatable relative to the drum 102.

During operation, the vibratory system 120 can cause the eccentric weight 260 to rotate relative to the frame 106 and the drum 102 to induce vibrational forces to the drum 102. Because the eccentric weight 260 can rotate relative to the frame 106 and the drum 102, the eccentric weight 260 can maintain a rotational velocity regardless of the drum 102 rotational speed.

Further, as shown in FIG. 2, the vibratory compactor machine 100 can be in electronic communication with a network 270, and in indirect communication with an external computing device 272. In various example, the network 270 can be a local area network (LAN), controller area network (CAN), or wide area network (WAN). In some such examples, the external computing device 272 can send and receive signals from the controller 132 of the vibratory compactor machine 100. For example, the controller 132 can send alerts to the external computing device 272.

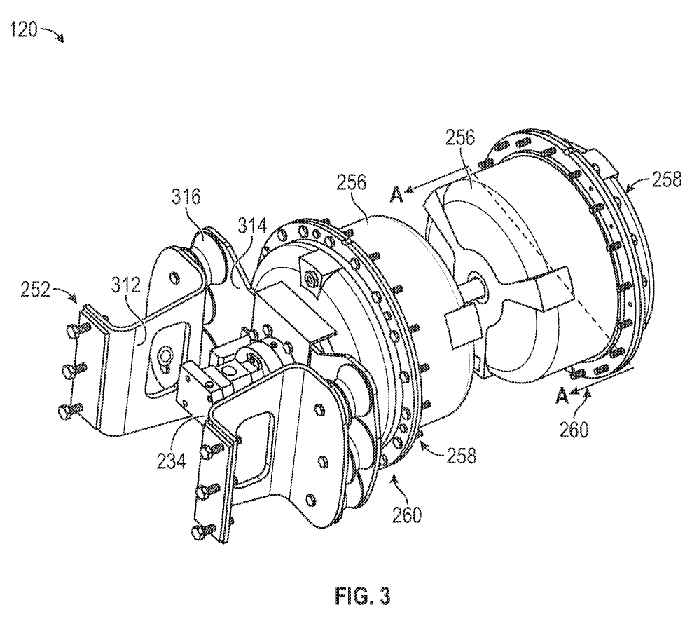

FIG. 3 is a perspective view of a portion of the vibratory system 120 of FIG. 2, as disposed within the drum 102. FIG. 3 shows the motor 234 coupled to the mount 252, which secures the motor 234 to the frame 106 (not shown in FIG. 3). Additionally, FIG. 3 illustrates the pods 256 (adapted to contain the eccentric weights 260 including fasteners 258 for coupling the pods 256 to the drum 102 (not shown in FIG. 3).

The mount 252 includes a first plate 312 secured to the frame 106 and a second plate 314 separated from the first plate by six ISO mounts 316. In various examples, the mount 252 can include more or fewer ISO mounts 316. In preferred examples, the larger the mass of the frame exerting a downforce on the drum, the more ISO mounts the mount 252 should include. The motor 234 is coupled to the second plate 314. The ISO mounts 316 are configured to reduce vibrational forces imparted from the vibratory system 120 into the frame 106.

FIGS. 4 and 5 illustrate the cross-section of the pod 256 taken along line A-A of FIG. 3. Shown in FIGS. 4 and 5, the eccentric weight 260 may include a body 402 that defines an internal cavity 404. The body 402 of the eccentric weight 260, which may be solid other than the internal cavity 404 and made of a metal or metallic material (e.g., steel or ductile iron), can define the internal cavity 404 such that the body 402 entirely surrounds the internal cavity 404. The body 402 may be formed in one-piece or as a unit, including optionally as part of the shaft 254. Accordingly, the internal cavity 404 can be cut or machined out from the body 402 or, alternatively, created using additive manufacturing techniques. Alternatively, according to one or more embodiments, the body 402 may have, include, or otherwise be coupled to opposing end plates that define end walls of the internal cavity 404 in the longitudinal direction along the longitudinal axis X of the shaft 254.

The internal cavity 404 can include a first section 412, a second section 414, and a third section 416 disposed between the first and second sections 412, 414. In various examples, the internal cavity 404 can include more or fewer sections than shown in FIGS. 4 and 5. Additionally or alternatively, the internal cavity 404 can include one or more sections not in communication with any of the first section 412, the second section 414, and the third section 416. Such sections may be provided to provide one or two additional vibration amplitudes for the vibratory system 120.

Filler material 420 may be provided in the internal cavity 404. The filler material 420 may be metal or metallic members, such as shot, steel balls, metal slugs, liquid metal, or sand, or a liquid, that can move or flow between the first section 412, the second section 414, and the third section 416. The filler material 420 may be movable in a controlled fashion between the first section 412, the second section 414, and the third section 416 based on rotation of the internal cavity 404 in correspondence with rotation of the shaft 254 (and the body 402).

In one mode of operation, to produce the first vibration amplitude, the filler material 420 can be provided in the first section 412 and then the internal cavity 404 be rotated clockwise. Because the filler material 420 is offset from a central axis 422 of the shaft 254 and the body 402, the filler material 420 can cause the eccentric weight 260 to vibrate at the first vibration amplitude.

In another mode of operation, to produce the second vibration amplitude, the filler material 420 can be provided in the second section 414 and then the internal cavity 404 be rotated counterclockwise. Because the filler material 420 is offset from the central axis 422 of the shaft 254 and the body 402, the filler material 420 can cause the eccentric weight 260 to vibrate at the second vibration amplitude.

In various examples, the vibratory system 120 can have eccentric weights configured to generate more than two vibratory modes. An example of eccentric weights configured to generate a plurality of vibratory modes is described in, for example, US Patent Application Publication No. 2011/0158745 (incorporated herein by reference). In such examples, the control scheme for the eccentric weight can facilitate three or more different vibratory amplitudes by controlling the location of weight (e.g., a degree of offset between a moveable mass and a fixed mass while rotating about a rotatable shaft), rotational speed, or other operational characteristics of the eccentric weight.

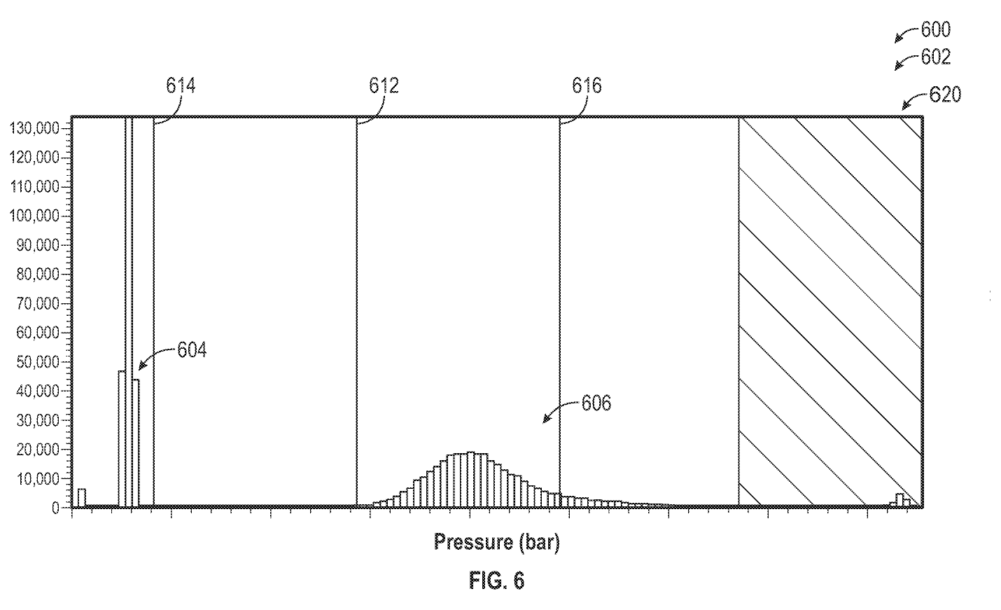

FIG. 6 illustrates example histogram 600 of differential pressure data 602 corresponding to non-vibing pressure data 604 and operating pressure data 606 of the vibratory system 120 of FIGS. 1–3. As shown in FIG. 6, the histogram includes a median 612 and one standard deviations 614, 616. In the illustrated example, the X-axis of the differential pressure data 600 is pressure. The X-axis can, in various examples, can correspond to different pressure scales (e.g., 0 bar to 250 bar, 400 bar, 600 bar, etc.). Additionally, in the illustrated example, the Y-axis of the histogram 600 measures the data points in each bin of the histogram 600. In the illustrated example, the differential pressure data 602 includes over 500,000 data points. In other examples, the differential pressure data 602 could measure over a longer or shorter period of time (e.g., daily, weekly, monthly, quarterly, yearly) and over a different differential pressure range.

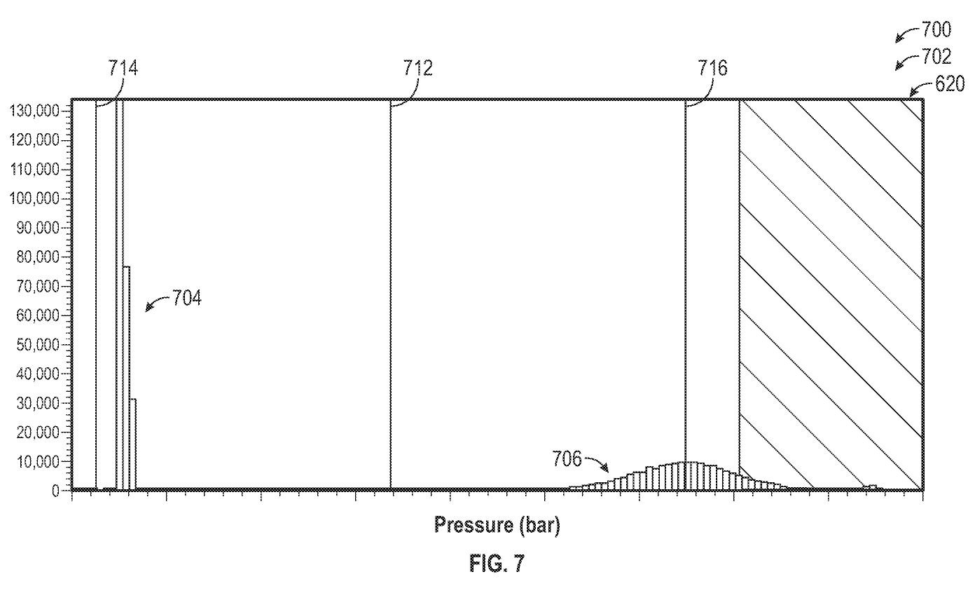

FIG. 7 illustrates example histogram 700 of differential pressure data 702 corresponding to non-vibrating pressure data 704 and operating pressure data 706 of the vibratory system 120 of FIGS. 1–3. As shown in FIG. 7, the histogram includes a median 712 and one standard deviations 714, 716. In the illustrated example, the X-axis of the differential pressure data 700 is pressure. The X-axis can, in various examples, can correspond to different pressure scales (e.g., 0 bar to 250 bar, 400 bar, 600 bar, etc.). Additionally, in the illustrated example, the Y-axis of the histogram 700 measures the data points in each bin of the histogram 700. In the illustrated example, the differential pressure data 702 includes over 400,000 data points. In other examples, the differential pressure data 702 could measure over a longer or shorter period of time and over a different differential pressure range.

As shown in FIG. 6, most of the differential pressure data 602 is within one standard deviation 614, 616 of the median 612. In contrast, as shown in FIG. 7, approximately half of the operating pressure data 706 is more than one standard deviation 716 from the median 712. In some examples, large amounts of differential pressure data beyond a standard deviation from the median (e.g., median 612, 712) can be indicative of pressures that could damage or unnecessarily increase wear on vibratory compactor machine 100 components and parts.

Alternatively, in some examples, the histograms 600, 700 can be used to measure if a predetermined quantity of data points are within or beyond a threshold 620. The threshold 620 can be predetermined to quickly identify when the vibratory system 120 is being operated in a manner likely to cause damage or increased/accelerated wear. Further, extended operational time within or beyond the threshold 620 can be used to calculate a reduction in health or life of one or more components of the vibratory system 120. For example, the number of data points within the operating pressure data 706 disposed within the threshold 620 could be utilized to calculate a reduction of operational hours the iso-mounts can be expected to operate in their designed capacity.

### INDUSTRIAL APPLICABILITY

The present vibratory system 120 is applicable in a wide variety of construction and road paving applications for identifying a state of health of the vibratory system 120 and/or the vibratory compactor machine 100. As used herein, the state of health generally refers to the condition of a component of the vibratory system 120. In some examples, the state of health can be measured as a proportion or percentage of useful component life (e.g., 50 percent (%) of useful life remaining). Alternatively, the state of health could be a classification of the component operation. In some such examples, the state of health could identify a component as “fully operational,” “reduced efficiency,” “maintenance required,” “replacement recommended.”

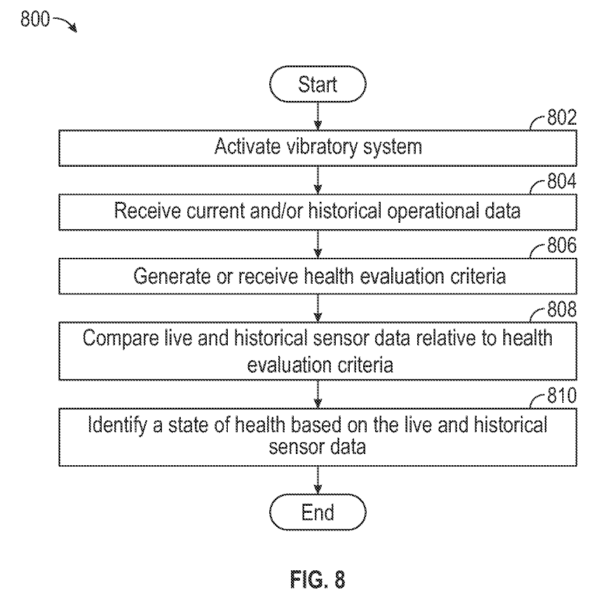

FIG. 8 illustrates an example method of identifying the state of health of the vibratory system 120 or the vibratory compactor machine 100. In various examples, the controller 132 identifies a state of health of the vibratory system and/or the vibratory compactor machine 100. Alternatively, a computer remote from the vibratory compactor machine 100 can identify a state of health of the vibratory system 120 or the vibratory compactor machine 100. In some examples, the health condition can be indicative of a failure state of a component of the vibratory system 120.

At block 802, the controller 132 activates the vibratory system 120 of the vibratory compactor machine 100. For example, the controller 132 activates the hydraulic pump 230 to activate the hydraulic motor 234. In some examples, activating the vibratory system 120 includes receiving a command from an operator of the vibratory compactor machine 100. For example, the operator can select the vibratory system 120 to operate in either the first state or the second state (described above in connection with FIGS. 4 and 5). In other examples, the controller 132 may automatically activate the vibratory system 120 based on operating within a worksite, receiving an activation command from an external system, or detecting a level of compaction of a worksite surface 101.

At block 804, the controller 132 receives, or accesses from memory, current and/or historical operational data. In various examples, the operational data can include information related to the hours the vibratory compactor machine 100 was operational in a worksite, the hours of time the vibratory system 120 spent in the first and second states, daily average operating pressures, vibratory system start-up time, and other sensed conditions relating to the operation and condition of the vibratory compactor machine 100. In some examples, the controller 132 receives current sensor data corresponding to the operation of the vibratory compactor machine 100 and/or the vibratory system 120.

At block 806, the controller 132 generates or receives, from a local memory or remote server, a health evaluation criteria. In various examples, the health evaluation criteria can correspond to wear of the drum 102, the hydraulic motor 234, ISO mounts 316, and various other parts of the vibratory compactor machine 100 and/or the vibratory system 120.

In one example, when the health evaluation criteria relates to health of a drum and/or health of a pad on a padfoot drum, the health evaluation criteria is based on the startup time of the vibratory system 120. For example, if the vibratory system 120 has shorter startup times, this could be indicative of a pad on the drum 102 having reduced mass due to being partially or totally worn out. In such an example, the health evaluation criteria is able to evaluate the health of the drum or the pad on the drum 102 and, in some examples, calculate or predict an expected timeline to replace the pad on the drum 102. In some such examples, the state of health could be identified as a having a proportion or percentage of remaining life.

In another example, the health evaluation criteria relates to material buildup on the drum 102. In such an example, if the vibratory system 120 exceeds a normalized startup time, the controller can determine that the mass of the drum 102 is higher than expected and can result in reduced efficacy of the vibratory system 120 and/or damage to the vibratory compactor machine 100. In such an example, the health evaluation criteria can ascertain the material buildup is beyond a desired threshold and maintenance activity (e.g., cleaning the drum) could facilitate maintaining the life of the drum 102.

In yet other examples, the health evaluation criteria relates to the hydraulic system 110 of the vibratory system 120. In such an example, the controller 132 can calculate mechanical and volumetric efficiency of the hydraulic motor 234. The mechanical or volumetric efficiency dropping beneath a predetermined threshold can be indicative of wear or failure of one or more components of the hydraulic system 110. In some examples, a longer startup time can also be indicative of wear or failure of one or more components of the hydraulic system 110. In such an example, the health evaluation criteria can be configured to identify a specific component of the vibratory system 120 is operating below a desired or expected efficiency. Accordingly, the health evaluation criteria can determine the state of health of the hydraulic system 110 as, for example, “fully operational,” “reduced efficiency,” “maintenance required,” “replacement recommended.”

In yet further examples, the health evaluation criteria relates to wear or failure of the ISO mounts 316. In various examples, a determination of excessive wear conditions can be determined based on increased differential pressures measured across the hydraulic motor 234. Alternatively, the health evaluation criteria could identify abnormal differential pressures outside of expected differential pressures for given operating conditions. In one example, high differential pressures can be indicative of operating conditions that accelerate the wear of the ISO mounts 316. Alternatively, low differential pressures could indicate that the ISO mounts 316 are absorbing more of the operating stresses than would normally be expected. Additionally or alternatively, wear or failure of the ISO mounts 316 can be ascertained by alignment with unique hydraulic pressure patterns. In such an example, the health evaluation criteria can include matching or correlating differential pressure data to a predetermined pressure trace. Similarly, as discussed above in connection with FIGS. 6 and 7, the increased differential pressure can be compared to a threshold differential pressure value, sufficiently exceeding standard deviation of median differential pressure values, exceed a threshold amount of data points above a threshold (e.g., threshold 620), or matching a shape of histograms associated with damage or wear of vibratory compactor machine 100 components. In some such examples, the data points are used to calculate wear and tear on the iso-mounts. Alternatively, in other examples, the data points are directly indicative of wear on the iso-mounts. In the foregoing examples, the state of health of the iso-mounts 316 can be identified as a proportion of remaining life of the iso-mounts 316 or as a condition category, such as, “fully operational,” “reduced efficiency,” “replacement recommended.”

In some examples, the health evaluation criteria related to the ISO mounts 316 further evaluates operating conditions of the vibratory compactor machine 100 to identify when differential pressures are elevated beyond an expected differential pressure value. For example, the vibratory compactor machine 100 can include sensors to evaluate the level of compaction of the worksite surface 101 because the level of compaction can affect the differential pressure across the hydraulic motor 234. In such examples, an already compact worksite surface 101 can result in high differential pressures across the hydraulic motor 234. In one example, the controller 132 can utilize a machine drive power (MDP) evaluation or compaction meter value (CMV) determination to determine if a high differential pressure across the hydraulic motor 234 is necessary for given operating conditions. For example, the MDP evaluation involves comparing operating drive power to a baseline drive power to ascertain rolling resistance of the vibratory compactor machine 100. In various examples, the rolling resistance is useable to determine the level of compaction. Alternatively, the CMV utilizes a drum-mounted accelerometer to measure the level of compaction of the worksite surface. Based on the foregoing, the controller 132 can evaluate two or more of: the differential pressure (described above), the machine drive power, and the compaction meter value to accurately identify when high differential pressures are indicative of excessive loads placed on the ISO mounts 316 or a worn condition of the ISO mounts 316. In one such example, the differential pressure could indicate either the ISO mounts 316 were being subjected to higher operating pressures, but evaluating the machine drive power could limit warnings of accelerated wear conditions based on the higher differential pressures being necessary for compacting the surface material.

Additionally, in various examples, health evaluation criteria can include two or more of the foregoing health evaluation criteria to identify the health of the vibratory compactor machine 100 overall. For example, the health evaluation criteria can include analysis of the hydraulic system, engine, and/or drum at the same time. In some examples, two or more health evaluation criteria are evaluated to increase the accuracy of a component state of health identification while in other examples, two or more components of the vibratory system 120 are evaluated separately.

At block 808, the controller 132 compares the live and/or historical sensor data against the health evaluation criteria. In some examples, the controller 132 is evaluating a single variable relative to a threshold. In other examples, the controller 132 is evaluating one or more variables against a set of thresholds or within a health evaluation algorithm. During some operating conditions, the controller 132 can determine if the sensor data is useful in indicating a state of health of one or more components of the vibratory system 120.

At block 810, the controller 132 identifies a state of health of one or more components of the vibratory compactor machine 100 and/or the vibratory system 120. The identification of health is based on the controller determining the live and/or historical sensor data satisfies the health evaluation criteria. In some examples, the identification of a state of health is based on satisfying the health evaluation criteria over a measured period of time. In some examples, the controller 132 further calculates a failure timeline.

In some examples, the controller 132 also sends an alert after (a) identifying a poor health of a component of the vibratory system; (b) the vibratory system 120 is operating at high pressures beyond a threshold that could cause premature wear of vibratory system 120 components, and/or (c) predicting failure of a component of the vibratory compactor machine 100 and/or the vibratory system 120. The alert can be transmitted to the user interface 130 of the vibratory compactor machine 100 or to the external computing device 272 located in, for example, a worksite office. In various such examples, the external computing device 272 can provide the alert to a seller, owner, maintenance manager, worksite supervisor, and/or operator of the vibratory compactor machine 100. The alert can include information regarding the operating conditions of the vibratory compactor machine 100, the state of health of one or more components of the vibratory compactor machine 100, the predicted failure of the vibratory compactor machine 100, and recommended action to maintain or repair the vibratory compactor machine 100. In some examples, reports of the operating conditions, state of health of one or more components, and predicted failures of any components can be generated at regular intervals (e.g., monthly, quarterly, yearly).

Various examples are illustrated in the figures and foregoing description. One or more features from one or more of these examples may be combined to form other examples.

The above detailed description is intended to be illustrative, and not restrictive. The scope of the disclosure should, therefore, be determined with reference to the appended claims, along with the full scope of equivalents to which such claims are entitled.

1. A system for monitoring a vibratory system of a vibratory compactor machine, comprising:
a vibratory system associated with a drum of the vibratory compactor machine;
a sensor associated with the vibratory system; and
a controller in electrical communication with the sensor, configured to:
receive sensor data from the sensor;
compare the sensor data to a criteria;
identify a state of health of the vibratory system based on the sensor data satisfying the criteria for a period of time.

2. The system of claim 1, wherein the vibratory system further includes a hydraulic pump and a hydraulic motor.

3. The system of claim 2, wherein the sensor is a pressure sensor associated with the hydraulic pump and the hydraulic motor.

4. The system of claim 3, wherein the pressure sensor is a differential pressure sensor

5. The system of claim 2, wherein vibratory system includes:
at least one mount;
a shaft rotatably coupled to the mount;
a motor coupled to the shaft; and
an eccentric weight disposed on the shaft;

6. The system of claim 6, wherein the criteria is a percentage above a vibratory pressure limit for a predetermined period of time.

7. The system of claim 6, wherein the criteria includes matching a predetermined pressure trace.

8. The system of claim 1, wherein the controller further generates an alert based on a prediction of failure of the vibratory system.

9. A vibratory compactor machine, comprising:
a compactor machine including:
a frame;
an engine secured to the frame;
a drum rotatable relative to the frame and operatively coupled to the engine; and
a vibratory system including:
a mount indirectly secured to the drum;
a motor fixedly secured to the mount; and
an eccentric weight operably coupled to the motor;
a sensor associated with the vibratory system; and
a controller in electrical communication with the sensor, configured to:
receive sensor data from the sensor;
compare the sensor data to a criteria; and
identify a state of health of the vibratory system based on the sensor data satisfying the criteria.

10. The system of claim 11, wherein the vibratory system further includes a hydraulic pump and a hydraulic motor.

11. The system of claim 12, wherein the sensor is a pressure sensor associated with the hydraulic pump and the hydraulic motor.

12. The system of claim 13, wherein the pressure sensor is a differential pressure sensor

13. The system of claim 15, wherein the criteria is a percentage above a vibratory pressure condition for a predetermined period of time.

14. The system of claim 15, wherein the criteria includes matching a predetermined pressure trace.

15. The system of claim 11, wherein the controller further generates an alert based on the state of health being indicative of a failure of the vibratory system.

16. A method of predicting failure of a vibratory system of a vibratory compactor machine, comprising:
activating a motor of a vibratory system including at least one mount, a shaft rotatably coupled to the mount, and an eccentric weight disposed on the shaft, wherein activation of the motor causes the eccentric weight to rotate about the shaft or with the shaft;
receiving, at a controller, sensor data generated by a sensor operably coupled to the vibratory system;
identifying, via the controller, the sensor data satisfies a criteria; and
identifying, via the controller, a state of health of the vibratory system based on the sensor data satisfying the criteria.

17. The method of claim 16, wherein the sensor data includes differential pressure data.

18. The method of claim 16, wherein the criteria is a percentage above a vibratory pressure condition for a predetermined period of time.

19. The method of claim 16, wherein the criteria is a correlation to a pressure trace.

20. The method of claim 16, further including generating an alert based on the prediction of failure of the vibratory system.
